(19) United States
(12) Patent Application Publication
(10) Pub. No.: US 2017/0049105 A1
(43) Pub. Date: Feb. 23, 2017

(54) FUNGICIDAL MIXTURES BASED ON TRIAZOLES

(71) Applicant: BASF SE, Ludwigshafen (DE)

(72) Inventors: Eberhard AMMERMANN, Heppenheim (DE); Reinhard STIERL, Freinsheim (DE); Gisela LORENZ, Neustadt (DE); Siefgried STRATHMANN, Limburgerhof (DE); Klaus SCHELBERGER, Goennheim (DE); V. James SPADAFORA, Sugar Land, TX (US); Thomas CHRISTEN, Dannstadt-Schauernheim (DE)

(21) Appl. No.: 15/198,143

(22) Filed: Jun. 30, 2016

Related U.S. Application Data
(63) Continuation of application No. 13/159,661, filed on Jun. 14, 2011, now abandoned.
Application No. 13/159,661 is a division of application No. 10/505,964, filed on Aug. 27, 2004, now abandoned.

(30) Foreign Application Priority Data
Mar. 7, 2002 (DE) 10209937.5

(51) Int. Cl. A01N 43/653

(52) U.S. Cl. CPC A01N 43/653

(57) ABSTRACT

A fungicidal mixture, comprising
(1) 2-[2-(1-chlorocyclopropyl)-3-(2-chlorophenyl)-2-hydroxy-propyl]-2,4-dihydro-[1,2,4]-triazole-3-thione (prothioconazole) of the formula I or a salt or adduct thereof

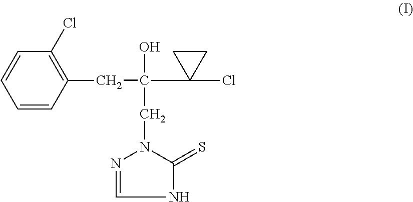 [SMILES: OC(Cc1ccccc1Cl)(Cn1nc[nH]c1=S)C1(Cl)CC1]

and at least one further triazole or a salt or adduct thereof, selected from the group consisting of
(2) epoxiconazole of the formula II

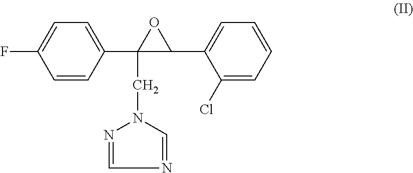 [SMILES: Fc1ccc(C2(Cn3cncn3)OC2c2ccccc2Cl)cc1]

and
(3) metconazole of the formula III

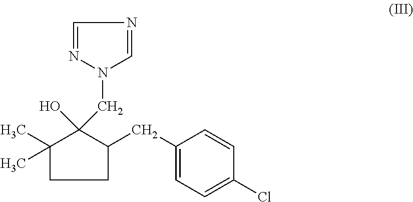 [SMILES: CC1(C)CCC(Cc2ccc(Cl)cc2)C1(O)Cn1cncn1]

This application is a continuation of U.S. application Ser. No. 13/159,661, filed Jun. 14, 2011, the entire contents of which is hereby incorporated herein by reference. U.S. application Ser. No. 13/159,661, is a divisional of U.S. application Ser. No. 10/505,964, filed Aug. 27, 2004, the entire contents of which is incorporated herein by reference. U.S. application Ser. No. 10/505,964, is a National Stage application of International Application No. PCT/EP2003/02188, filed Mar. 4, 2003. U.S. application Ser. No. 10/505,964 also claims priority under 35 U.S.C. §119 to German Patent Application No. 10209937.5 filed Mar. 7, 2002.

The present invention relates to fungicidal mixtures, comprising
(1) 2-[2-(1-chlorocyclopropyl)-3-(2-chlorophenyl)-2-hydroxypropyl]-2,4-dihydro-[1,2,4]-triazole-3-thione (prothioconazole) of the formula I or a salt or adduct thereof

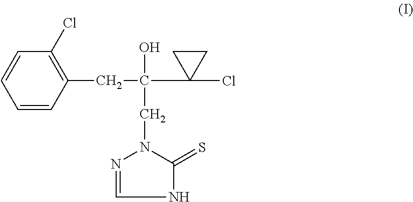 [SMILES: OC(Cc1ccccc1Cl)(Cn1nc[nH]c1=S)C1(Cl)CC1]

and at least one further triazole or a salt or adduct thereof, selected from the group consisting of
(2) epoxiconazole of the formula II

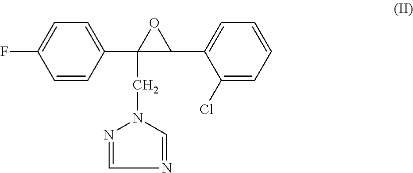 [SMILES: Fc1ccc(C2(Cn3cncn3)OC2c2ccccc2Cl)cc1]

and
(3) metconazole of the formula III

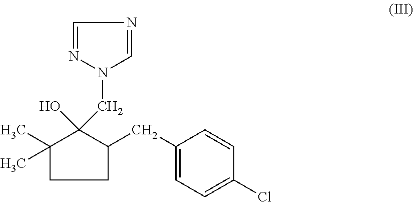 [SMILES: CC1(C)CCC(Cc2ccc(Cl)cc2)C1(O)Cn1cncn1]

(4) propiconazole of the formula IV

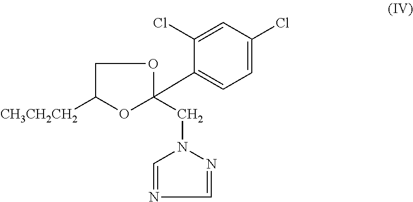

and
(5) fluquinconazole of the formula V

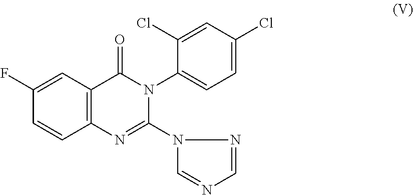 [SMILES: O=c1c2cc(F)ccc2nc(-n2cncn2)n1-c1ccc(Cl)cc1Cl]

and
(6) penconazole of the formula VI

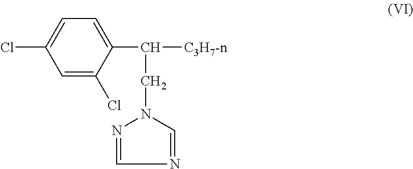

and
(7) difenconazole of the formula VII

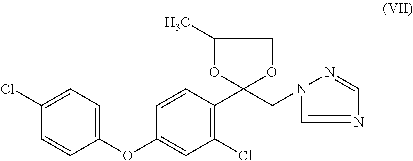 [SMILES: CC1COC(Cn2cncn2)(c2ccc(Oc3ccc(Cl)cc3)cc2Cl)O1]

and
(8) hexaconazole of the formula VIII

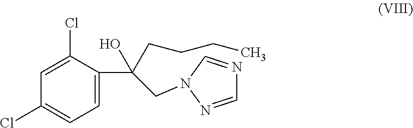 [SMILES: CCCCC(O)(Cn1cncn1)c1ccc(Cl)cc1Cl]

and
(9) cyproconazole of the formula IX

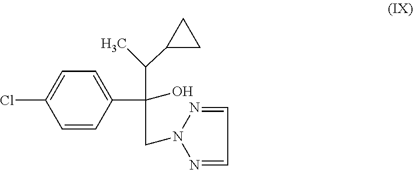 [SMILES: CC(C1CC1)C(O)(Cn1nccn1)c1ccc(Cl)cc1]

and
(10) flusilazole of the formula X

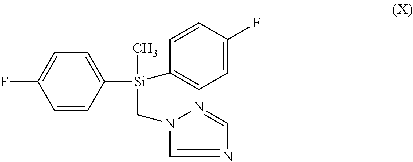 [SMILES: C[Si](Cn1cncn1)(c1ccc(F)cc1)c1ccc(F)cc1]

and
(11) tetraconazole of the formula XI

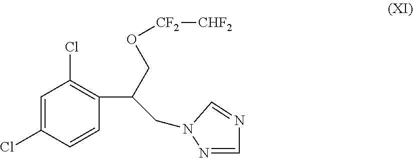

and
(12) fenbuconazole of the formula XII

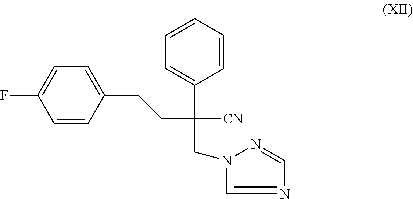 [SMILES: N#CC(CCc1ccc(F)cc1)(Cn1cncn1)c1ccccc1]

and
(13) myclobutanil of the formula XIII

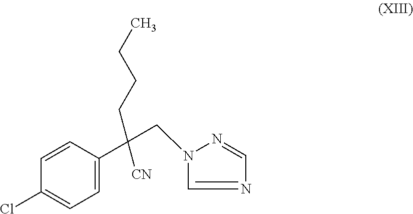 [SMILES: CCCCC(C#N)(Cn1cncn1)c1ccc(Cl)cc1]

and
(14) simeconazole of the formula XIV

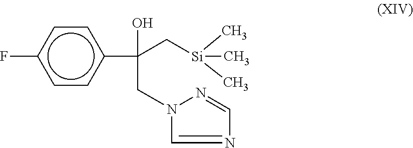

and
(15) ipconazole of the formula XV

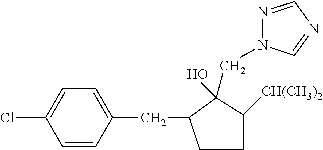 [SMILES: CC(C)C1CCC(Cc2ccc(Cl)cc2)C1(O)Cn1cncn1]

and
(16) triticonazole of the formula XVI

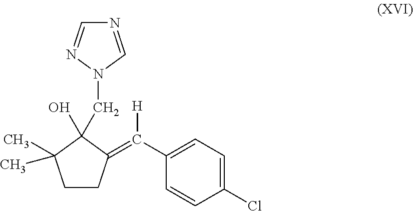 [SMILES: CC1(C)CC/C(=C\c2ccc(Cl)cc2)C1(O)Cn1cncn1]

in a synergistically effective amount.

Moreover, the invention relates to a method for controlling harmful fungi using mixtures of the compound I and at least one of the compounds II to XVI, and to the use of the compound I and at least one of the compounds II to XVI for preparing such mixtures, and to compositions comprising these mixtures.

Prothioconazole of the formula I, i.e. 2-[2-(1-chlorocyclopropyl)-3-(2-chlorophenyl)-2-hydroxypropyl]-2,4-dihydro-[1,2,4]-triazole-3-thione, is already known from WO 96/16048.

WO 98/47367 discloses a number of active compound combinations of prothioconazole with a large number of other fungicidal compounds.

Epoxiconazole of the formula II and its use as crop protection agent are described in EP-B 0 196 038.

Metconazole of the formula III, too, is already known and is described in EP-B 0 267 778.

Propiconazole of the formula IV, too, is already known and is described in DE-A 2551560.

Fluquinconazole of the formula V is described in the Pesticide Manual, 12th Ed. (2000), page 449.

Penconazole of the formula VI is described in the Pesticide Manual, 12th Ed. (2000), page 712.

Difenconazole of the formula VII is known from EP-A-0 112 284.

Hexaconazole of the formula VIII is described in DE-A-30 42 303.

Cyproconazole of the formula IX is described in DE-A-34 06 993.

Flusilazole of the formula X is known from EP-A-0 068 813.

Tetraconazole of the formula XI is known from EP-A-0 234 242.

Fenbuconazole of the formula XII is described in DE-A-37 21 786.

Myclobutanil of the formula XIII is described in EP-A-0 145 294.

Simeconazole of the formula XIV is described in The BCPC Conference—Pests and Diseases 2000, pp. 557-562.

Ipconazole of the formula XV is described in EP-A-0 267 778.

Triticonazole of the formula XVI is described in EP-A-0 378 953.

It is an object of the present invention to provide mixtures which have an improved activity against harmful fungi combined with a reduced total amount of active compounds applied (synergistic mixtures), with a view to reducing the application rates and improving the activity spectrum of the known compounds I to XVI.

We have found that this object is achieved by the mixture, defined at the outset, of prothioconazole with at least one further triazole. Moreover, we have found that applying the compound I and at least one of the compounds II to XVI simultaneously, i.e. together or separately, or applying the compound I and at least one of the compounds I to XVI in succession provides better control of harmful fungi than is possible with the individual compounds alone.

2-[2-(1-Chlorocyclopropyl)-3-(2-chlorophenyl)-2-hydroxypropyl]-2,4-dihydro-[1,2,4]-triazole-3-thione (prothioconazole) of the formula I is known from WO 96-16 048. The compound can be present in the “thiono” form of the formula

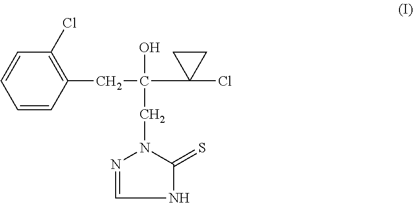 [SMILES: OC(Cc1ccccc1Cl)(Cn1nc[nH]c1=S)C1(Cl)CC1]

or in the tautomeric “mercapto” form of the formula

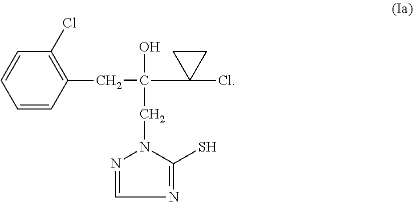 [SMILES: OC(Cc1ccccc1Cl)(Cn1ncnc1S)C1(Cl)CC1]

For the sake of simplicity, only the “thiono” form is shown in each case.

Epoxiconazole of the formula II

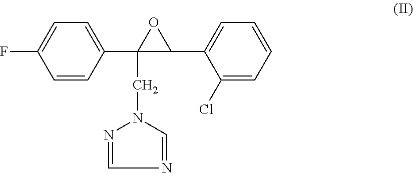 [SMILES: Fc1ccc(C2(Cn3cncn3)OC2c2ccccc2Cl)cc1]

is known from EP-B 0 196 038.

Metconazole of the formula III

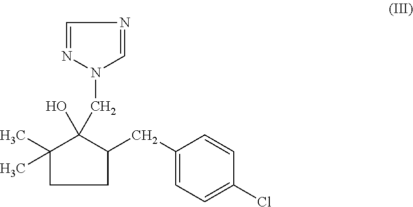 [SMILES: CC1(C)CCC(Cc2ccc(Cl)cc2)C1(O)Cn1cncn1]

is known from EP-B 0 267 778.

Propiconazole of the formula IV

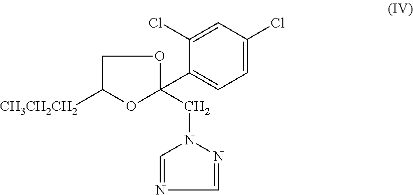

is known from DE-A 25 51 560.

Fluquinconazole of the formula V

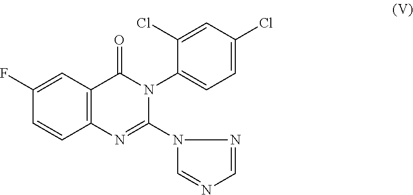 [SMILES: O=c1c2cc(F)ccc2nc(-n2cncn2)n1-c1ccc(Cl)cc1Cl]

is described in the Pesticide Manual, 12th Ed. (2000), page 449.

Penconazole of the formula VI

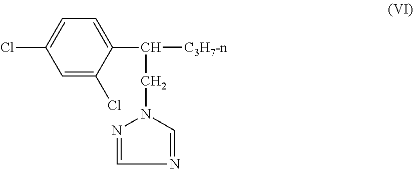

is described in the Pesticide Manual, 12th Ed. (2000), page 712.

Difenconazole of the formula VII

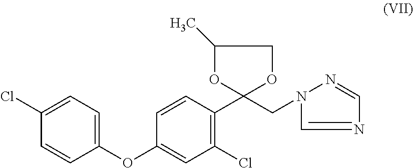 [SMILES: CC1COC(Cn2cncn2)(c2ccc(Oc3ccc(Cl)cc3)cc2Cl)O1]

is known from EP-A-0 112 284.

Hexaconazole of the formula VIII

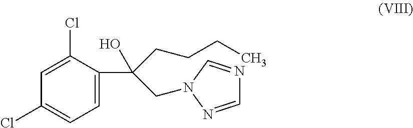 [SMILES: CCCCC(O)(Cn1cncn1)c1ccc(Cl)cc1Cl]

is described in DE-A-30 42 303.

Cyproconazole of the formula IX

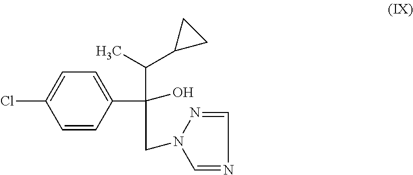 [SMILES: CC(C1CC1)C(O)(Cn1cncn1)c1ccc(Cl)cc1]

is described in DE-A-34 06 993.

Flusilazole of the formula X

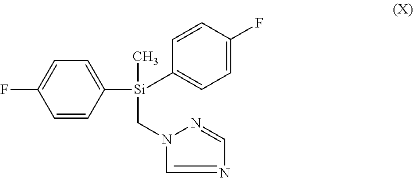 [SMILES: C[Si](Cn1cncn1)(c1ccc(F)cc1)c1ccc(F)cc1]

is known from EP-A-0 068 813.

Tetraconazole of the formula XI

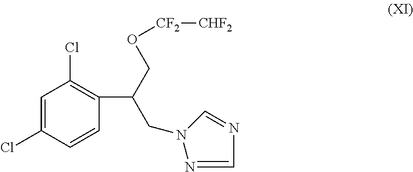

is known from EP-A-0 234 242.

Fenbuconazole of the formula XII

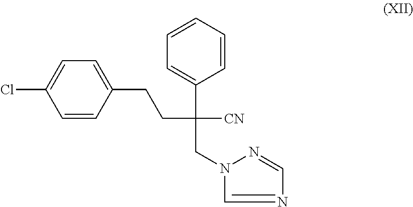 [SMILES: N#CC(CCc1ccc(Cl)cc1)(Cn1cncn1)c1ccccc1]

is described in DE-A-37 21 786.

Myclobutanil of the formula XIII

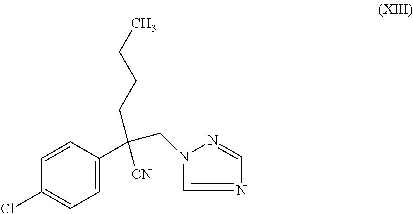 [SMILES: CCCCC(C#N)(Cn1cncn1)c1ccc(Cl)cc1]

is described in EP-A-0 145 294.

Simeconazole of the formula XIV

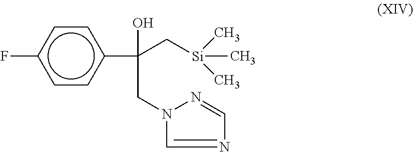

is known from The BCPC Conference—Pests and Diseases 2000, pp. 557-562.

Ipconazole of the formula XV

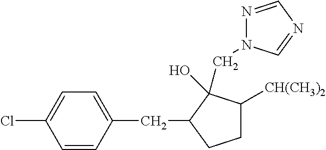 [SMILES: CC(C)C1CCC(Cc2ccc(Cl)cc2)C1(O)Cn1cncn1]

is described in EP-A-0 267 778.

Triticonazole of the formula XVI

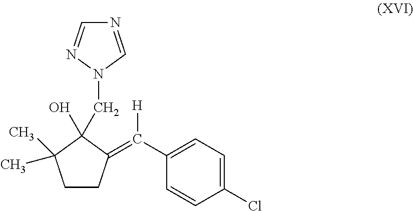 [SMILES: CC1(C)CC/C(=C\c2ccc(Cl)cc2)C1(O)Cn1cncn1]

is described in EP-A-0 378 953.

Owing to the basic character of their nitrogen atoms, the compounds I to XVI are capable of forming salts or adducts with inorganic or organic acids or with metal ions.

Examples of inorganic acids are hydrohalic acids, such as hydrogen fluoride, hydrogen chloride, hydrogen bromide and hydrogen iodide, carbonic acid, sulfuric acid, phosphoric acid and nitric acid.

Suitable organic acids are, for example, formic acid, and alkanoic acids, such as acetic acid, trifluoroacetic acid, trichloroacetic acid and propionic acid, and also glycolic acid, thiocyanuric acid, lactic acid, succinic acid, citric acid, benzoic acid, cinnamic acid, oxalic acid, alkylsulfonic acid (sulfonic acids having straight-chain or branched alkyl radicals of 1 to 20 carbon atoms), arylsulfonic acids or -disulfonic acids (aromatic radicals, such as phenyl or naphthyl, which carry one or two sulfonic acid groups), alkylphosphonic acids (phosphonic acids having straight-chain or branched alkyl radicals of 1 to 20 carbon atoms), arylphosphonic acids or -diphosphonic acids (aromatic radicals, such as phenyl and naphthyl, which carry one or two phosphonic acid radicals), where the alkyl or aryl radicals may carry further substituents, for example p-toluenesulfonic acid, salicylic acid, p-aminosalicylic acid, 2-phenoxybenzoic acid, 2-acetoxybenzoic acid, etc.

Suitable metal ions are in particular the ions of the elements of the second main group, in particular calcium and magnesium, of the third and fourth main group, in particular aluminum, tin and lead, and also of the first to eighth transition group, in particular chromium, manganese, iron, cobalt, nickel, copper, zinc and others. Particular preference is given to the metal ions of the elements of the transition groups of the fourth period.

The metals can be present in the various valences that they can assume.

Preference is given to mixtures of prothioconazole with epoxiconazole.

Furthermore, preference is also given to mixtures of prothioconazole with metconazole.

Preference is also given to mixtures of prothioconazole with propiconazole.

Preference is furthermore given to mixtures of prothioconazole with fluquinconazole.

Preference is furthermore given to mixtures of prothioconazole with penconazole.

Preference is furthermore given to mixtures of prothioconazole with difenconazole.

Preference is furthermore given to mixtures of prothioconazole with hexaconazole.

Preference is furthermore given to mixtures of prothioconazole with cyproconazole.

Preference is furthermore given to mixtures of prothioconazole with flusilazole.

Preference is furthermore given to mixtures of prothioconazole with tetraconazole.

Preference is furthermore given to mixtures of prothioconazole with fenbuconazole.

Preference is furthermore given to mixtures of prothioconazole with myclobutanil.

Preference is furthermore given to mixtures of prothioconazole with simeconazole.

Preference is furthermore given to mixtures of prothioconazole with ipconazole.

Preference is furthermore given to mixtures of prothioconazole with triticonazole.

Preference is also given to ternary mixtures of prothioconazole with two other of the triazoles described above.

When preparing the mixtures, it is preferred to employ the pure active compounds I to XVI, to which can be added further active compounds against harmful fungi or against other pests, such as insects, arachnids or nematodes, or else herbicidal or growth-regulating active compounds or fertilizers.

The mixtures of the compound I and at least one of the compounds II to XVI or the compound I and at least one of the compounds II to XVI used simultaneously, jointly or separately, exhibit outstanding activity against a wide range of phytopathogenic fungi, in particular from the classes of the Ascomycetes, Basidiomycetes, Phycomycetes and Deuteromycetes. Some of them act systemically and can therefore also be employed as folio- and soil-acting fungicides.

They are especially important for controlling a large number of fungi in a variety of crop plants, such as cotton, vegetable species (for example cucumbers, beans, tomatoes, potatoes and cucorbits), barley, grass, oats, bananas, coffee, corn, fruit species, rice, rye, soya, grapevine, wheat, ornamentals, sugarcane, and a variety of seeds.

They are particularly suitable for controlling the following phytopathogenic fungi: Blumeria graminis (powdery mildew) in cereals, Erysiphe cichoracearum and Sphaerotheca fuliginea in cucorbits, Podosphaera leucotricha in apples, Uncinula necator in grapevines, Puccinia species in cereals, Rhizoctonia species in cotton, rice and lawns, Ustilago species in cereals and sugarcane, Venturia inaequalis (scab) in apples, Helminthosporium species in cereals, Septoria nodorum in wheat, Botrytis cinera (gray mold) in strawberries, vegetables, ornamentals and grapevines, Cercospora arachidicola in groundnuts, Pseudocercosporella herpotrichoides in wheat and barley, Pyricularia oryzae in rice, Phytophthora infestans in potatoes and tomatoes, Plasmopara viticola in grapevines, Pseudoperonospora species in hops and cucumbers, Alternaria species in vegetables and fruit, Mycosphaerella species in bananas and also Fusarium and Verticillium species.

They can furthermore be employed in the protection of materials (for example the protection of wood), for example against Paecilomyces variotii.

The compound I and at least one of the compounds II to XVI can be applied simultaneously, that is either together or separately, or successively, the sequence, in the case of separate application, generally not having an effect on the result of the control measures.

The compounds I and II are usually employed in a weight ratio of from 20:1 to 1:20, in particular from 10:1 to 1:10, preferably from 5:1 to 1:5.

The compounds I and III are usually employed in a weight ratio of from 20:1 to 1:20, in particular from 10:1 to 1:10, preferably from 5:1 to 1:5.

The compounds I and IV are usually employed in a weight ratio of from 20:1 to 1:20, in particular from 10:1 to 1:10, preferably from 5:1 to 1:5.

The compounds I and V are usually employed in a weight ratio of from 20:1 to 1:20, in particular from 10:1 to 1:10, preferably from 5:1 to 1:5.

The compounds I and VI are usually employed in a weight ratio of from 20:1 to 1:20, in particular from 10:1 to 1:10, preferably from 5:1 to 1:5.

The compounds I and VII are usually employed in a weight ratio of from 20:1 to 1:20, in particular from 10:1 to 1:10, preferably from 5:1 to 1:5.

The compounds I and VIII are usually employed in a weight ratio of from 20:1 to 1:20, in particular from 10:1 to 1:10, preferably from 5:1 to 1:5.

The compounds I and IX are usually employed in a weight ratio of from 20:1 to 1:20, in particular from 10:1 to 1:10, preferably from 5:1 to 1:5.

The compounds I and X are usually employed in a weight ratio of from 20:1 to 1:20, in particular from 10:1 to 1:10, preferably from 5:1 to 1:5.

The compounds I and XI are usually employed in a weight ratio of from 20:1 to 1:20, in particular from 10:1 to 1:10, preferably from 5:1 to 1:5.

The compounds I and XII are usually employed in a weight ratio of from 20:1 to 1:20, in particular from 10:1 to 1:10, preferably from 5:1 to 1:5.

The compounds I and XIII are usually employed in a weight ratio of from 20:1 to 1:20, in particular from 10:1 to 1:10, preferably from 5:1 to 1:5.

The compounds I and XIV are usually employed in a weight ratio of from 20:1 to 1:20, in particular from 10:1 to 1:10, preferably from 5:1 to 1:5.

The compounds I and XV are usually employed in a weight ratio of from 20:1 to 1:20, in particular from 10:1 to 1:10, preferably from 5:1 to 1:5.

The compounds I and XVI are usually employed in a weight ratio of from 20:1 to 1:20, in particular from 10:1 to 1:10, preferably from 5:1 to 1:5.

Depending on the kind of effect desired, the application rates of the mixtures according to the invention are, in particular in agricultural crop areas, from 0.01 to 8 kg/ha, preferably from 0.1 to 5 kg/ha, in particular from 0.1 to 3.0 kg/ha.

The application rates for the compound I are from 0.01 to 1 kg/ha, preferably from 0.05 to 0.5 kg/ha, in particular from 0.05 to 0.3 kg/ha.

Correspondingly, the application rates for the compound II are from 0.01 to 1 kg/ha, preferably from 0.02 to 0.5 kg/ha, in particular from 0.05 to 0.3 kg/ha.

Correspondingly, the application rates for the compound III are from 0.01 to 1 kg/ha, preferably from 0.02 to 0.5 kg/ha, in particular from 0.05 to 0.3 kg/ha.

Correspondingly, the application rates for the compound IV are from 0.01 to 1 kg/ha, preferably from 0.02 to 0.5 kg/ha, in particular from 0.05 to 0.3 kg/ha.

Correspondingly, the application rates for the compound V are from 0.01 to 1 kg/ha, preferably from 0.02 to 0.5 kg/ha, in particular from 0.05 to 0.3 kg/ha.

Correspondingly, the application rates for the compound VI are from 0.01 to 1 kg/ha, preferably from 0.02 to 0.5 kg/ha, in particular from 0.05 to 0.3 kg/ha.

Correspondingly, the application rates for the compound V are from 0.01 to 1 kg/ha, preferably from 0.02 to 0.5 kg/ha, in particular from 0.05 to 0.3 kg/ha.

Correspondingly, the application rates for the compound VII are from 0.01 to 1 kg/ha, preferably from 0.02 to 0.5 kg/ha, in particular from 0.05 to 0.3 kg/ha.

Correspondingly, the application rates for the compound VIII are from 0.01 to 1 kg/ha, preferably from 0.02 to 0.5 kg/ha, in particular from 0.05 to 0.3 kg/ha.

Correspondingly, the application rates for the compound IX are from 0.01 to 1 kg/ha, preferably from 0.02 to 0.5 kg/ha, in particular from 0.05 to 0.3 kg/ha.

Correspondingly, the application rates for the compound X are from 0.01 to 1 kg/ha, preferably from 0.02 to 0.5 kg/ha, in particular from 0.05 to 0.3 kg/ha.

Correspondingly, the application rates for the compound XI are from 0.01 to 1 kg/ha, preferably from 0.02 to 0.5 kg/ha, in particular from 0.05 to 0.3 kg/ha.

Correspondingly, the application rates for the compound XII are from 0.01 to 1 kg/ha, preferably from 0.02 to 0.5 kg/ha, in particular from 0.05 to 0.3 kg/ha.

Correspondingly, the application rates for the compound XIII are from 0.01 to 1 kg/ha, preferably from 0.02 to 0.5 kg/ha, in particular from 0.05 to 0.3 kg/ha.

Correspondingly, the application rates for the compound XIV are from 0.01 to 1 kg/ha, preferably from 0.02 to 0.5 kg/ha, in particular from 0.05 to 0.3 kg/ha.

Correspondingly, the application rates for the compound XV are from 0.01 to 1 kg/ha, preferably from 0.02 to 0.5 kg/ha, in particular from 0.05 to 0.3 kg/ha.

Correspondingly, the application rates for the compound XVI are from 0.01 to 1 kg/ha, preferably from 0.02 to 0.5 kg/ha, in particular from 0.05 to 0.3 kg/ha.

For seed treatment, the application rates of the mixture are generally from 0.001 to 250 g/kg of seed, preferably 0.01 to 100 g/kg, in particular 0.01 to 50 g/kg.

If phytopathogenic harmful fungi are to be controlled, the separate or joint application of the compound I and at least one of the compounds II to XVI or of the mixtures of the compound I and at least one of the compounds II to XVI is effected by spraying or dusting the seeds, the plants or the soils before or after sowing of the plants, or before or after plant emergence.

The fungicidal synergistic mixtures according to the invention or the compound I and at least one of the compounds II to XVI can be formulated for example in the form of ready-to-spray solutions, powders and suspensions or in the form of highly concentrated aqueous, oily or other suspensions, dispersions, emulsions, oil dispersions, pastes, dusts, materials for broadcasting or granules, and applied by spraying, atomizing, dusting, broadcasting or watering. The use form depends on the intended purpose; in any case, it should ensure as fine and uniform as possible a distribution of the mixture according to the invention.

The formulations are prepared in a known manner, e.g. by adding solvents and/or carriers. The formulations are usually admixed with inert additives, such as emulsifiers or dispersants.

Suitable surfactants are the alkali metal salts, alkaline earth metal salts and ammonium salts of aromatic sulfonic acids, e.g. ligno-, phenol-, naphthalene- and dibutylnaphthalenesulfonic acid, and of fatty acids, alkyl- and alkylarylsulfonates, alkyl, lauryl ether and fatty alcohol sulfates, and salts of sulfated hexa-, hepta- and octadecanols, or of fatty alcohol glycol ethers, condensates of sulfonated naphthalene and its derivatives with formaldehyde, condensates of naphthalene or of the naphthalenesulfonic acids with phenol and formaldehyde, polyoxyethylene octylphenyl ether, ethoxylated isooctyl-, octyl- or nonylphenol, alkylphenol or tributylphenyl polyglycol ethers, alkylaryl polyether alcohols, isotridecyl alcohol, fatty alcohol/ethylene oxide condensates, ethoxylated castor oil, polyoxyethylene alkyl ethers or polyoxypropylene alkyl ethers, lauryl alcohol polyglycol ether acetate, sorbitol esters, lignosulfite waste liquors or methylcellulose.

Powders, materials for broadcasting and dusts can be prepared by mixing or jointly grinding the compound I and at least one of the compounds II to XVI or the mixture of the compound I and at least one of the compounds II to XVI with a solid carrier.

Granules (e.g. coated granules, impregnated granules or homogeneous granules) are usually prepared by binding the active compound, or active compounds, to a solid carrier.

Fillers or solid carriers are, for example, mineral earths, such as silica gels, silicas, silicates, talc, kaolin, limestone, lime, chalk, bole, loess, clay, dolomite, diatomaceous earth, calcium sulfate, magnesium sulfate, magnesium oxide, ground synthetic materials and fertilizers, such as ammonium sulfate, ammonium phosphate, ammonium nitrate, ureas, and products of vegetable origin, such as cereal meal, tree bark meal, wood meal and nutshell meal, cellulose powders or other solid carriers.

The formulations generally comprise from 0.1 to 95% by weight, preferably 0.5 to 90% by weight, of compound I and at least one of the compounds II to XVI or of the mixture of the compound I and at least one of the compounds II to XVI. The active compounds are employed in a purity of from 90% to 100%, preferably 95% to 100% (according to NMR spectrum or HPLC).

The compounds I to XVI, the mixtures, or the corresponding formulations, are applied by treating the harmful fungi, their habitat, or the plants, seeds, soils, areas, materials or spaces to be kept free from them with a fungicidally effective amount of the mixture, or of the compound I and at least one of the compounds II to XVI in the case of separate application.

Application can be effected before or after infection by the harmful fungi.

### USE EXAMPLE

The synergistic activity of the mixtures according to the invention was demonstrated by the following experiments:

The active compounds, separately or together, were formulated as a 10% emulsion in a mixture of 63% by weight of cyclohexanone and 27% by weight of emulsifier, and diluted with water to the desired concentration.

Evaluation was carried out by determining the infected leaf areas in percent. These percentages were converted into efficacies. The efficacy (W) was calculated as follows using Abbot's formula:

$$W = ( 1 - \frac{α}{β} ) \cdot 100$$

α corresponds to the fungal infection of the treated plants in % and
β corresponds to the fungal infection of the untreated (control) plants in %

An efficacy of 0 means that the infection level of the treated plants corresponds to that of the untreated control plants; an efficacy of 100 means that the treated plants were not infected.

The expected efficacies of the mixtures of the active compounds were determined using Colby's formula [R. S. Colby, Weeds 15, 20-22 (1967)] and compared with the observed efficacies.

Colby's formula: E=x+y−x·y/100
E expected efficacy, expressed in % of the untreated control, when using the mixture of the active compounds A and B at the concentrations a and b
x efficacy, expressed in % of the untreated control, when using active compound A at a concentration of a
y efficacy, expressed in % of the untreated control, when using active compound B at a concentration of b.

Use example 1: Activity against mildew of wheat caused by Erysiphe [syn. Blumeria] graminis forma specialis tritici

Leaves of wheat seedlings of the cultivar “Kanzler” grown in pots were sprayed to run-off point with an aqueous suspension having the concentration of active compounds stated below. The suspension or emulsion was prepared from a stock solution made using 10% of active compound in a mixture comprising 70% of cyclohexanone, 20% of wetting agent and 10% of emulsifier. 24 hours after the spraycoating had dried on, the leaves dusted with spores of mildew of wheat (Erysiphe [syn. Blumeria] graminis forma specialis tritici). The test plants were then placed in a greenhouse at 20-24° C. and 60-90% relative atmospheric humidity. After 7 days, the extent of the development of the mildew was determined visually in % infection of the entire leaf area.

The visually determined values for the percentage of diseased leaf area were converted into efficacies in % of the untreated control. An efficacy of 0 means the same disease level as in the untreated control, an efficacy of 100 means a disease level of 0%. The expected efficacies for the active compound combinations were determined using Colby's formula mentioned above and compared with the observed efficacies.

TABLE 1

| | Concentration of | |
|---|---|---|
| | active compound in | |
| | the spray liquor in | Efficacy in % of the |
| Active compound | ppm | untreated control |
| Control (untreated) | (90% infestation) | 0 |
| Compound I = | 4 | 56 |
| prothioconazole | 1 | 0 |
| | 0.25 | 0 |
| | 0.06 | 0 |
| | 0.015 | 0 |
| Compound II = | 1 | 44 |
| epoxiconazole | 0.25 | 33 |
| | 0.06 | 11 |
| Compound III = | 0.25 | 11 |
| metconazole | | |
| Compound XIII = | 4 | 56 |
| myclobutanil | 1 | 11 |
| | 0.06 | 0 |

TABLE 2

| Combinations according to the | Observed | Calculated |
|---|---|---|
| invention | efficacy | efficacy*) |
| Compound I = prothioconazole + | 78 | 44 |
| compound II = epoxiconazole | | |
| 0.06 + 1 ppm | | |
| Mischung 1:16 | | |
| Compound I = prothioconazole + | 78 | 33 |
| compound II = epoxiconazole | | |
| 0.015 + 0.25 ppm | | |
| mixture 1:16 | | |
| Compound I = prothioconazole + | 83 | 44 |
| compound II = epoxiconazole | | |
| 0.25 + 1 ppm | | |
| mixture 1:4 | | |
| Compound I = prothioconazole + | 83 | 33 |
| compound II = epoxiconazole | | |
| 1 + 0.25 ppm | | |
| mixture 4:1 | | |
| Compound I = prothioconazole + | 78 | 70 |
| compound II = epoxiconazole | | |
| 4 + 0.25 ppm | | |
| mixture 16:1 | | |
| Compound I = prothioconazole + | 44 | 11 |
| compound II = epoxiconazole | | |
| 1 + 0.06 ppm | | |
| mixture 16:1 | | |
| Compound I = prothioconazole + | 22 | 11 |
| compound III = metconazole | | |
| 0.015 + 0.25 ppm | | |
| mixture 1:16 | | |
| Compound I = prothioconazole + | 33 | 11 |
| compound III = metconazole | | |
| 0.06 + 0.25 ppm | | |
| mixture 1:4 | | |
| Compound I = prothioconazole + | 78 | 11 |
| compound III = metconazole | | |
| 1 + 0.25 ppm | | |
| mixture 4:1 | | |
| Compound I = prothioconazole + | 83 | 60 |
| compound III = metconazole | | |
| 4 + 0.25 ppm | | |
| mixture 16:1 | | |
| Compound I = prothioconazole + | 67 | 56 |
| compound XIII = myclobutanil | | |
| 0.25 + 4 ppm | | |
| mixture 1:16 | | |
| Compound I = prothioconazole + | 22 | 11 |
| compound XIII = myclobutanil | | |
| 0.25 + 1 ppm | | |
| mixture 1:4 | | |
| Compound I = prothioconazole + | 89 | 60 |
| compound XIII = myclobutanil | | |
| 4 + 1 ppm | | |
| mixture 4:1 | | |
| Compound I = prothioconazole + | 22 | 0 |
| compound XIII = myclobutanil | | |
| 1 + 0.06 ppm | | |
| mixture 16:1 | | |

*)efficacy calculated using Colby's formula

The test results show that in all mixing ratios the observed efficacy is higher than the efficacy calculated beforehand using Colby's formula (from Synerg 173. XLS).

1. A synergistic fungicidal mixture, comprising 2-[2-(1-chlorocyclopropyl)-3-(2-chlorophenyl)-2-hydroxypropyl]-2,4-dihydr-o-[1,2,4]-triazole-3-thione (prothioconazole) of the formula I or a salt or adduct thereof 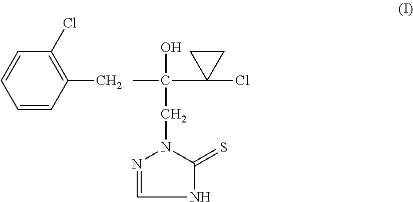
and fluquinconazole of the formula II 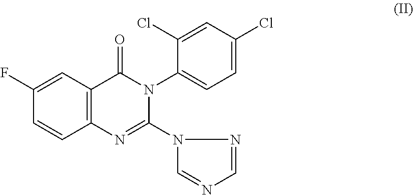 [SMILES: O=c1c2cc(F)ccc2nc(-n2cncn2)n1-c1ccc(Cl)cc1Cl]
or a salt or adduct thereof, wherein said fungicidal mixture comprises prothioconazole and fluquinconazole or a salt or adduct thereof in a synergistically effective amount.

2. The synergistic fungicidal mixture of claim 1, wherein the weight ratio of prothioconazole to fluquinconazole is from 20:1 to 1:20.

3. The synergistic fungicidal composition of claim 1, further comprising a solid or liquid carrier.

4. A fungicidal kit for making a synergistic mixture of fungicides comprising, in separate containers, prothioconozole, or salt or adduct thereof, and fluquinconazole, or salt or adduct thereof, wherein the fungicidal kit contains each of said prothioconozole, or salt or adduct thereof, and fluquinconazole, or salt or adduct thereof, in amounts sufficient to produce a synergistic mixture when combined.

5. A method for controlling harmful fungi, which comprises treating harmful fungi, their habitat or the plants, seeds, soils, areas, materials or spaces to be kept free from harmful fungi with a synergistic fungicidal mixture comprising a 2-[2-(1-chlorocyclopropyl)-3-(2-chlorophenyl)-2-hydroxypropl]-2,4-dihydr-o-[1,2,4]-triazole-3-thione (prothioconazole) of formula I or a salt or adduct thereof 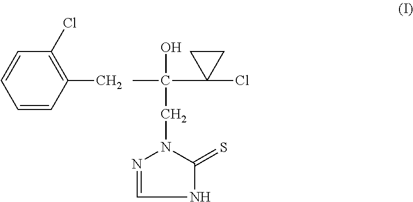
and a fluquinconazole of formula II 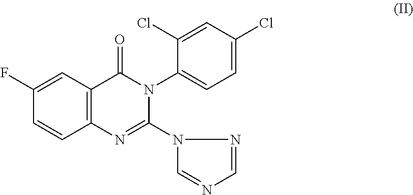 [SMILES: O=c1c2cc(F)ccc2nc(-n2cncn2)n1-c1ccc(Cl)cc1Cl]
or a salt or adduct thereof, wherein said fungicidal mixture comprises prothioconazole and fluquinconazole or a salt or adduct thereof in a synergistically effective amount.

6. The method of claim 5, comprising applying said synergistic fungicidal mixture to said harmful fungi, their habitat or the plants, seeds, soils, areas, materials or spaces to be kept free from said harmful fungi in an amount of from 0.01 to 8 kg/ha.

7. The synergistic fungicidal mixture of claim 1, wherein the prothioconazole and the fluquinconazole has a purity of at least 90%.

8. The synergistic fungicidal mixture of claim 1, wherein the weight ratio of prothioconazole to fluquinconazole is from 5:1 to 1:5.

9. The method of claim 5, wherein the prothioconazole and the fluquinconazole are applied simultaneously or successively.

10. The method of claim 5, comprising applying said synergistic fungicidal mixture to said harmful fungi, their habitat or the plants, seeds, soils, areas, materials or spaces to be kept free from said harmful fungi, wherein the fluquinconazole of formula II is applied in an amount of from 0.01 to 1 kg/ha.

11. The method of claim 5, wherein the synergistic mixture is applied to a plant, a seed, or a soil before or after sowing of the plants, or before or after plant emergence.

12. The method of claim 5, wherein the harmful fungi is selected from the group of species consisting of: Blumeria graminis, Erysiphe cichoracearum, Sphaerotheca fuliginea, Podosphaera leucotricha, Uncinula necator, Puccinia, Rhizoctonia, Ustilago, Venturia inaequalis, Helminthosporium, Septoria nodorum, Botrytis cinera, Cercospora arachidicola, Pseudocercosporella herpotrichoides, Pyricularia oryzae, Phytophthora infestans, Plasmopara viticolam, Pseudoperonospora, Alternaria, Mycosphaerella, Fusarium Verticillium, and Paecilomyces variotii.

13. The method of claim 5, comprising applying said synergistic fungicidal mixture to seeds to be kept free from said harmful fungi, wherein the application rates of the mixture to seeds are from 0.001 to 250 g/kg of seed.

14. A method for protecting crops from fungi comprising treating one or more crops, soils, areas, or materials with the synergistic fungicidal mixture of claim 1

15. The method of claim 14, wherein the crop is selected from the group consisting of cotton, cucumbers, beans, tomatoes, potatoes, cucorbits, barley, grass, oats, bananas, coffee, corn, fruit, rice, rye soya, grapevine, wheat, ornamentals, sugar cane, seeds, cereals, lawns, wheat, strawberries, ornamentals, groundnuts, hops, and apples.

16. A method for the protection of materials from harmful fungi comprising applying the synergistic fungicidal mixture of claim 1 to the material.

17. The method of claim 16, wherein the material is wood.

18. The method of claim 16, wherein the harmful fungi comprises Paecilomyces variotii.
